(19) United States
(12) Patent Application Publication
(10) Pub. No.: US 2016/0119012 A1
(43) Pub. Date: Apr. 28, 2016

(54) METAL SHELL AND CELL PHONE COMPRISING THE SAME

(71) Applicant: BYD COMPANY LIMITED, Shenzhen, Guangdong (CN)

(72) Inventors: Jiangang Zhou, Shenzhen (CN); Dajun Chen, Shenzhen (CN); Qing Gong, Shenzhen (CN)

(21) Appl. No.: 14/891,263

(22) PCT Filed: Jun. 24, 2014
(86) PCT No.: PCT/CN2014/080667

§ 371 Date: Nov. 13, 2015

(30) Foreign Application Priority Data
Jun. 26, 2013 (CN) 201310256597.1
Jun. 26, 2013 (CN) 201320368450.7

(51) Int. Cl. H04B 1/3888; H04B 5/02; H04M 1/02

(52) U.S. Cl. CPC H04B 1/3888; H04M 1/0202; H04B 5/02

(57) ABSTRACT

A metal shell includes: a metal body having a through hole; a plastic member disposed on the metal body at a position of the through hole; and a NFC antenna disposed on a surface of the plastic member and configured to receive a signal via the through hole. An area of a part of the NFC antenna overlapping the through hole is larger than one third of an area of the NFC antenna. A cell phone including the metal shell is also provided.

### CROSS-REFERENCE TO RELATED APPLICATION

This application claims priority and benefits of Chinese Patent Application Nos. 201310256597.1 and 201320368450.7, both filed with State Intellectual Property Office, P. R. C. on Jun. 26, 2013, the entire contents of the above-identified applications are incorporated herein by reference.

### FIELD

The present disclosure relates to a field of cell phone, especially relates to a metal shell and a cell phone including the metal shell.

### BACKGROUND

Depending on magnetic coupling, a NFC (Near Field Communication) antenna may work normally. As well as we know, a metal component may greatly influence the NFC antenna. Some device (i.e., a cell phone) must be provided with a non-metallic part for receiving the NFC antenna, such that the NFC antenna can communicate with the outside device normally. However, due to requirements of strength and manufacturing process, those parts for the NFC antenna are required to be made of metal, thus causing an incompatibility between the function of the NFC antenna and the metal shell. Then, some device such as cell phones, could not realize the NFC function with the NFC antenna. In order to realize the NFC function, the shell of the cell phone must be mounted on a nonmetal plastic area.

### SUMMARY

Embodiments of the present disclosure seek to solve at least one of the problems existing in the prior art to at least some extent, or to provide a consumer with a useful commercial choice.

Embodiments of the present disclosure provide a metal shell. The metal shell according to embodiments of the present disclosure includes: a metal body having a through hole; a plastic member disposed on the metal body at a position of the through hole; and a NFC antenna disposed on a surface of the plastic member and configured to receive a signal via the through hole, in which an area of a part of the NFC antenna overlapping the through hole is larger than one third of an area of the NFC antenna.

Embodiments of the present disclosure also provide a cell phone. The cell phone according to embodiments of the present disclosure includes the metal cell mentioned above.

According to embodiments of the present disclosure, the through hole is formed in the metal body and used for transmitting signals; therefore the influence from the metal body on the signal, for example, a wireless radio frequency signal, may be avoided. Also, the NFC antenna is fixed to the metal body via the plastic member. The metal shell according to embodiments of the present disclosure may have a compact structure and an aesthetic appearance.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the accompanying drawings, in which:

FIG. 1 is a schematic view of a metal shell according to one embodiment of the present disclosure;

FIG. 2 is a schematic view of a metal shell according to one embodiment of the present disclosure;

FIG. 3 is a schematic view of a metal shell according to one embodiment of the present disclosure; and

FIG. 4 is a schematic view of a metal shell according to one embodiment of the present disclosure.

### DETAILED DESCRIPTION

Reference will be made in detail to embodiments of the present disclosure. The embodiments described herein with reference to drawings are explanatory, illustrative, and used to generally understand the present disclosure. The embodiments shall not be construed to limit the present disclosure. The same or similar elements and the elements having same or similar functions are denoted by like reference numerals throughout the descriptions.

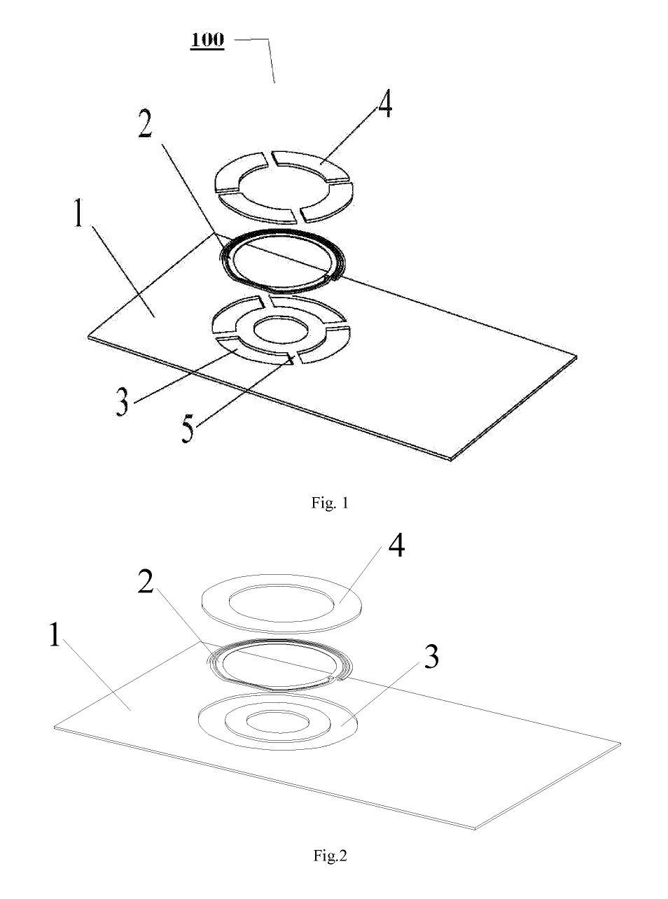

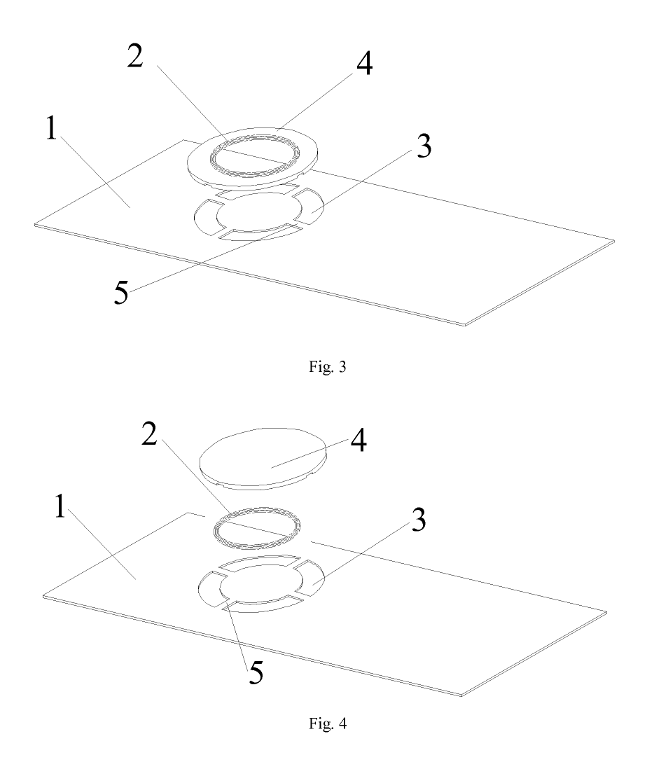

Embodiments of the present disclosure provide a metal shell 100. As shown in FIGS. 1 and 2, the metal shell 100 according to embodiments of the present disclosure includes: a metal body 1 having a through hole 3, a plastic member 4 disposed on the metal body 1 at a position of the through hole 3, and a NFC antenna 2 disposed on a surface of the plastic member 4 and configured to receive a signal via the through hole 3. In some embodiments, an area of a part of the NFC antenna 2 overlapping the through hole 3 is larger than one third of an area of the NFC antenna 2. In other words, the area of a projection that the part of the NFC antenna 2 projects into the area of the through hole 3 is larger than one third of the area of a projection that the NFC antenna 2 projects into a plane defined by the through hole 3. It should be noted that, in the present disclosure, the area of the NFC antenna may refer to an area of a projection that the NFC antenna projects into the plane defined by the through hole 3.

In one embodiment, the metal body 1 includes a plurality of through holes 3, and two adjacent through 3 holes are connected via a rib 5. In some embodiments, the plurality of through holes 3 are distributed uniformly in the metal body 1.

In some embodiments, the NFC antenna 2 is located within the through hole 3, and a distance between a peripheral of the through hole 3 and the NFC antenna 2 is about 0.1 millimeters to about 3.0 millimeters. For example, a distance between the peripheral of the through hole 3 and a coil of the NFC antenna 2 in a radial direction of the through hole 3 is about 0.1 millimeters to about 3.0 millimeters. Then the signal received by the NFC antenna 2 may have an improved intensity.

It should be noted that there are no particular limitations for methods for disposing the plastic member 4 on the metal body 1, any common method known by those skilled in the art may be used in the present disclosure. For example, in some embodiments, the plastic member 4 is disposed on the metal body 1, with a part of the plastic member 4 filled in the through hole 3, via in-mold injection molding. In some other embodiments, the plastic member 4 is disposed on the metal body 1, with a part of the plastic member 4 filled in the through hole 3, via a snapping fit.

It should be noted that there are no particular limitations for the material of the metal body 1, any commonly used metal material known by those skilled in the art may be used in the present disclosure. For example, in some embodiments, the metal body 1 is made of copper, copper alloy, aluminum, aluminum alloy, stainless steel, and any combinations thereof.

It should be noted that there are no particular limitations for the material of the plastic member 4, any commonly used metal material known by those skilled in the art may be used in the present disclosure. For example, in some embodiments, the plastic member 4 is made of at least one selected from a group consisting of polycarbonate (PC), a mixture of polycarbonate and sodium dodecylbenzene sulfonate (PC+ABS), and polyformaldehyde (POM).

There are no particular limitations for a shape of the NFC antenna 2, any common shape known by those skilled in the art may be used in the present disclosure. In some embodiments, the NFC antenna 2 has a shape of circular ring. It should be noted that the central hole within the circular ring may be used for decorating or mounting a LOGO. In some embodiments, the decorating part or LOGO may be made of metal or plastic.

In some embodiments, the metal shell 100 further includes a ferrite sheet disposed on a surface of the NFC antenna. Then the signal received by the NFC antenna may have an improved intensity. In one embodiment, the ferrite sheet is disposed on the NFC antenna 2 via a double-sided tape.

Embodiments of the present disclosure also provide a cell phone, which includes the metal shell 100 mentioned above.

The metal shell 100 and cell phone according to embodiments of the present disclosure will be described in details with reference to the following examples.

### Example 1

The present example provides a method for preparing a metal shell and the metal shell made therefrom. Four through holes having the same size were formed in a metallic shell by pouching, in which two adjacent through holes of the four through holes were connected via a rib, thus forming a metal body having a shape substantially corresponding to a NFC antenna. An area of a part of the NFC antenna overlapping the trough hole was two thirds of an area of the NFC antenna, and a distance between a peripheral of the through hole and a coil of the NFC antenna was 0.1 millimeters. Then the NFC antenna was fixed in a corresponding position, and the NFC antenna, the metal body, and a plastic member were integrally formed via in-mold injection molding. A feed contact of the NFC antenna was exposed externally so as to meet the contact requirements. Then a metal shell A1 is obtained.

### Example 2

The method for preparing the metal shell A2 of Example 2 has substantially the same steps as Example 1, except for the following differences: the through hole formed in the metal body had a shape of circular ring, and the distance between a peripheral of the through hole and the coil of the NFC antenna was 3.0 millimeters.

### Example 3

The method for preparing a metal shell A3 of Example 3 includes substantially the same steps as Example 1, except for the following differences: the NFC antenna and the plastic member were integrally formed to obtain an integral component, a first snapping element was formed on the integral component, and a second snapping element corresponding to the first snapping element was formed on the metal shell, and the integral component and the metal body was connected with each other via a snapping fit, i.e. the first and second snapping elements; the area of the part of the NFC antenna overlapping the through hole was one third of the area of the NFC antenna; and the distance between the peripheral of the through hole and the coil of the NFC antenna was 1.0 millimeter.

### Example 4

The method for preparing a metal shell A4 of Example 4 includes substantially the same steps as Example 1, except for the following differences: the plastic member was molded independently, a third snapping element was formed on the plastic member, the NFC antenna was disposed on the plastic member, a fourth snapping element corresponding to the third snapping element was formed on the metal shell, and the metal part and the plastic member were connected via a snapping fit, i.e. the third and fourth snapping elements; the area of the part of the NFC antenna overlapping the through hole was four fifths of the area of the NFC antenna; and the distance between a peripheral of the through hole and the coil of the NFC antenna was 2.0 millimeters.

The metal shell according to embodiments of the present disclosure has a simple structure and an aesthetic appearance, while maintaining the intensity of the received signal.

Reference throughout this specification to “an embodiment,” “some embodiments,” “one embodiment”, “another example,” “an example,” “a specific example,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments can not be construed to limit the present disclosure, and changes, alternatives, and modifications can be made in the embodiments without departing from spirit, principles and scope of the present disclosure.

1. A metal shell, comprising:
a metal body having a through hole;
a plastic member disposed on the metal body at a position of the through hole; and
a NFC antenna disposed on a surface of the plastic member and configured to receive a signal via the through hole, wherein an area of a part of the NFC antenna overlapping the through hole is larger than one third of an area of the NFC antenna.

2. The metal shell of claim 1, wherein the metal body comprises a plurality of through holes, and two adjacent through holes are connected via a rib.

3. The metal shell of claim 1, wherein the NFC antenna is located within the through hole, and a distance between a periphery of the through hole and the NFC antenna is about 0.1 millimeters to about 3.0 millimeters.

4. The metal shell of claim 1, wherein the plastic member is disposed on the metal body via in-mold injection molding.

5. The metal shell of claim 1, wherein the plastic member is disposed on the metal body via a snapping fit.

6. The metal shell of claim 1, wherein the metal body is made of at least one selected from a group consisting of copper, aluminum, stainless steel, and alloys thereof.

7. The metal shell of claim 1, wherein the plastic member is made of at least one selected from a group consisting of polycarbonate, a mixture of polycarbonate and sodium dodecylbenzene sulfonate, and polyformaldehyde.

8. The metal shell of claim 1, further comprising a ferrite sheet disposed on a surface of the NFC antenna.

9. The metal shell of claim 8, wherein the ferrite sheet is disposed on the NFC antenna via a double-sided tape.

10. A cell phone, comprising a metal shell including:
a metal body having a through hole;
a plastic member disposed on the metal body at a position of the through hole; and
a NFC antenna disposed on a surface of the plastic member and configured to receive a signal via the through hole, wherein an area of a part of the NFC antenna overlapping the through hole is larger than one third of an area of the NFC antenna.

11. The cell phone of claim 10, wherein the metal body comprises a plurality of through holes, and two adjacent through holes are connected via a rib.

12. The cell phone of claim 10, wherein the NFC antenna is located within the through hole, and a distance between a periphery of the through hole and the NFC antenna is about 0.1 millimeters to about 3.0 millimeters.

13. The cell phone of claim 10, wherein the plastic member is disposed on the metal body via in-mold injection molding.

14. The cell phone of claim 10, wherein the plastic member is disposed on the metal body via a snapping fit.

15. The cell phone of claim 10, wherein the metal body is made of at least one selected from a group consisting of copper, aluminum, stainless steel, and alloys thereof.

16. The cell phone of claim 10, wherein the plastic member is made of at least one selected from a group consisting of polycarbonate, a mixture of polycarbonate and sodium dodecylbenzene sulfonate, and polyformaldehyde.

17. The cell phone of claim 10, wherein the metal shell further includes a ferrite sheet disposed on a surface of the NFC antenna.

18. The cell phone of claim 10, wherein the ferrite sheet is disposed on the NFC antenna via a double-sided tape.
